(19) United States
(12) Patent Application Publication
(10) Pub. No.: US 2005/0287467 A1
(43) Pub. Date: Dec. 29, 2005

(54) Enhanced durability printing plates and method of making

(76) Inventors: Jeffrey G. Zaloom, Waukesha, WI (US); Zhengzhe Song, Vernon Hills, IL (US); David C. Tanck, Oak Creek, WI (US)

Correspondence Address: GENERAL CHEMICAL PERFORMANCE PRODUCTS LLC., 90 EAST HALSEY ROAD, PARSIPPANY, NJ, 07054, US

(21) Appl. No.: 10/880,403

(22) Filed: Jun. 29, 2004

(51) Int. Cl. G03C 1/52

(52) U.S. Cl. 430/167

(57) ABSTRACT

A metal substrate printing plate is provided comprising a surface layer of a photosensitive composition containing azide compound, an IR sensitive dye, a crosslinkable polymer resin and an adhesion promoting resin that is put through a post thermal process during the manufacturing of the plate. This special thermal treatment allows for improved mechanical and chemical resistance as well as affording run lengths up to one million impressions after imaging and processing.

This invention relates to polymer coated printing plates in which the coating has a substantially improved durability, and to methods of preparing such printing plates.

### BACKGROUND OF THE INVENTION

Printing plates have a surface coating that requires it be able to be exposed and imaged efficiently with high resolution. Also, the plate must be capable of printing uniformly onto various substrates to produce high quality images, economically and to have an effective and durable press life such that it is capable of running hundreds of thousands of copies.

Printing plates may comprise a variety of substrates that are well known in the art and include, for example, grained or anodized aluminum, copper and aluminum, copper and steel and the like. Generally, printing plates made from lithographic grade aluminum are first treated to clean their surfaces; the surface is grained or roughened so as to have a topography, providing surface depressions on the order of about one micron which enhances the adhesion of a photopolymer coating, then the surface is anodized to improve durability. The surface is then treated to render it hydrophilic.

In the case of a grained aluminum plate, the surface is usually oxidized or anodized, forming an aluminum oxide coating. The oxide layer is formed by treating with phosphoric or sulfuric acids using an electrochemical process. The oxidized surface is then passivated, as with a silicate coating and/or a polyvinyl phosphonic acid coating, to inhibit aluminum corrosion. This step produces a smooth coating that is durable and has low porosity.

In preparing the plate for printing, an image-forming layer, such as a photoresist, is applied over the treated aluminum plate. For laser thermal imaging, which is computer controlled, the plate must be able to withstand all of the processing steps including, deposition of the photoresist, imaging of the photoresist, and development of the photoresist, without adhesion loss of the photoresist to the substrate. The printing plate is then baked to “harden” the resist in.

In addition, the photoresist must have a wide development latitude, that is, the development of the photoresist after exposure, must be as long as necessary to provide as much of a difference, i.e., as development latitude, as possible between exposed and unexposed areas of the resist. A wide development latitude enhances the capability of using an increased photospeed, so that the resist can be exposed rapidly, increasing its reliability and providing flexibility for the choice of materials and exposure to the end user.

As noted hereinabove, various printing plates are available and known to those skilled in the art; each kind being characterized by its unique performance and durability. As a general proposition a printing plate with a substantially extended press life is highly desirable because an extended useful life can result in a reduction of significant replacement costs when the plate performance deteriorates.

Thus, it is the object of the present invention to prepare a printing plate that not only has a superior surface characteristic but provides a substantially increased printing life capable of making uniformly clear image print quality for extended usage time of a magnitude of the order of nearly double the quantity capable from prior art printing plates.

### SUMMARY OF THE INVENTION

In accordance with the invention a photosensitive composition which comprises an azide compound, IR sensitive dye, crosslinkable polymer resin and an adhesion promoting resin applied to the printing plate substrate is put through a special post thermal process during the manufacturing of the plate. We have discovered that, this special thermal post treatment imparts to the printing surface a very substantial improved mechanical and chemical resistance, resulting in printing plate that can attain useful run lengths as high as one million impressions.

The post or thermal treatment of the coated substrate is effected at a temperature in the order of about 125° C. (257° F.) to about 133° C. (270° F.) with residence times on the order of about 90 to about 95 seconds.

### DETAILED DESCRIPTION OF THE INVENTION

Preparation of the coated substrate comprising the printing plates composite of the invention prior to the thermal treatment is effected in a manner known in the art. Illustrative of suitable polymer coating over metal substrate methods systems are those disclosed, for example, in U.S. Pat. Nos. 5,962,192; 6,037,085 and 6,664,019; and co-pending U.S. application Ser. Nos. 09/902,416 and 10/390,980, the relevant disclosure of which is incorporated herein by reference.

The invention will be further described by application to a commercial available aluminum printing plate. However, application of the coating and thermal processing system of the invention is not to be construed as restricted to a printing plate comprising any particular metal substrate. It is to be understood that the invention may be applied to any of the known conventional metallic substrate printing plates that are coated with an IR Sensitive dye with a polymeric resin which can sustain a post curing thermal processing regime, i.e., a post-baking.

We have discovered that this controlled thermal treatment of the cured polymer coated printing plate, imparts a surprising improvement to the mechanical and chemical resistance of the printing surface resulting in run lengths approaching one million impressions. A typical illustrative operable procedure may compromise the following:

Using a commercially available lithographic grade aluminum of about 0.008-0.020 inch thick, the following treatment is applied:
(a) The metal is cleaned to remove grease and dirt by immersing the plate for about 30-45 seconds in a caustic aqueous solution, e.g., sodium hydroxide (26-28 grams/liter) and about 3.7 grams/liter of sodium gluconate which keeps the aluminum salts solubilized, and heated to a temperature of about 140° F. The aluminum metal is then rinsed with de-ionized (hereinafter DI) water.
(b) The cleaned aluminum is grained by immersing in a solution of ammonium biflouride for about 45 seconds, and heated to about 130° F. The ammonia bifluoride is typically employed at a concentration of about 75 to about 105 grams/liter, preferably about 90 grams/liter. The aluminum plate is again rinsed in DI water.
(c) Once grained, the aluminum is sprayed with a 5-30% by volume solution of 42 Baume nitric acid to de-smut the surface.
(d) The aluminum is then sprayed with hot water (160-180° F.) to initiate the formation of an oxide layer and promptly immersed in a solution including about 8-12 grams/liter of sodium acetate, about 1 gram/liter of sodium carbonate and sufficient trisodium phosphate to control the pH of the solution within a range of from about 10.5 to about 11.5. After heating the solution at a temperature of about 160° F.-200° F. for about 2 minutes, the aluminum is immersed in the acetate/carbonate/trisodium phosphate solution for about 30-60 seconds to substantially complete the formation of the oxide layer. The aluminum metal is again rinsed with DI water.
(e) The oxidized aluminum metal is then silicated by immersing for about 30-45 seconds in a solution containing about 15-25 ml/liter of silicate solution commercially available from PQ Corporation under their brand name STAR™. The treating solution was heated to about 150° F.-180° F. for a period of about 60 to about 150 seconds and the aluminum is again rinsed with DI water and dried.

It is to be noted that the method of the present invention omits a separate anodization step. However, the hot water rinse and acetate steps ensures adherence of the resist on the aluminum printing plate, and permits the aluminum plate to behave similarly to prior art aluminum plate, such as copper clad bimetal plates. Additionally, the method of the present invention reduces the number of steps required to prepare a high quality printing plate having excellent surface coating-to-substrate adhesion, wide development latitude and remarkable durability.

A positive photoresist, such as described in U.S. Pat. No. 5,962,192, can be applied to the treated aluminum surface by spin coating or similar method. These positive photoresists are made from an organoazide compound mixed with a suitable polymeric resin and incorporate one or more dyes that are sensitive to light emitted by the particular laser used for exposure.

Additional ingredients, such as a pigment that improved the contrast between the resist layer and an underlying substrate, and surfactants, designed to adjust the texture of the resist so that it will form a smooth coating and will have a uniform thickness on the prepared aluminum plate, can also be added.

Typically, lithographic resists of the present type have a dry thickness of about 80-120 microinches. The above mixture is dissolved in a suitable organic solvent system so that it can be applied to the printing plates as a thin film having a uniform thickness. The solids preferably are generally present at a concentration of about 3-5% by weight in the organic solvent.

Polymeric resins suitable for use in the photoresist include polyvinyl formal resin and its derivatives, polymers and copolymers of acrylates and methacrylates, styrene, and the like.

Suitable organoazide compounds include mono or multi functional compounds that generally have more than one azide group. The azide compounds are used in conjunction with suitable dyes, such as infrared absorbing dyes, that are photosensitive to the light emitted by the particular laser used for patterning the resist.

Flood exposure by ultra violet light causes the organoazides in the coating to cross-link with the polymeric resins.

In accordance with the invention a post thermal treatment of the coated printing plate is effected to impart a marked improvement in the chemical and abrasion resistance of the coated surface. This thermal treatment is believed to structurally rearrange the cross-linked polymeric resin. It is believed that this rearrangement contributes substantially to the improved chemical abrasion resistance of the finished printing plate.

The thermal curing is effected at temperatures ranging from about 120° C. to about 150° C. for resistance times depending on the temperature applied and for a period of time on the order of about 50 to about 150 seconds and may be performed in a plurality of stages. For example, thermal post curing of the coating printing plate may be effected in a first zone or stage oven at about 125° C. to about 150° C.; at about 120° C. to about 140° C. in a second stage; and about 125° C. to about 135° C. in a third stage. Residence time in each stage typically is on the order of about 20 to about 50 seconds.

It is also believed that subjecting the coated plate to a high intensity laser light excites electrons in the IR Dyes and transform the light into heat energy. Heat energy is transmitted to the cross-linked resist, tends to decrease the degree of cross-linking, and makes the photo resist more soluble in a developer solvent. It is apparent that the dye chosen for the present invention must be sensitive to the frequency of the laser used and must be able to absorb the radiation from the laser and convert the radiation to heat.

The resist is then developed using conventional developer solutions and equipment. The developer solubilizes the exposed regions of the resist, and rinses it away. The presence of a pigment is advantageous because one can determine visually when removed the resist has reached down to the substrate in the image-exposed regions.

The resultant aluminum printing plates will carry printing inks, which can be transferred to another medium, such as paper, providing commercially acceptable printing impressions as high and even higher than one million impressions on press.

The invention will be further described in the following example; but the invention is not meant to be limited to the details described therein.

### EXAMPLE 1

The photoresist solution was prepared by dissolving 3.31 parts of polyvinyl formal resin, 0.3 parts of modified polyvinyl formal resin, 0.31 part of azido bis(2,6-benzylidene) cyclohexanone, 0.35 parts of Projet 830, IR Dye available from Aveeia and 0.02 parts of the surfactant FC-431 (available from 3M Company), in 96 parts of a mixture of 66:33% of Xylene and dimethyl acetamide solvent system.

The solution was filtered and then spin-coated onto an aluminum substrate surface (of the kind described hereinabove) at a rate of 60 rpm for 1 minute, dried for 2 minutes at 270° F. The plate was exposed to ultraviolet light at 200 mJ/cm².

The plate was then image exposed using a computer controlled diode laser with 830 mm wavelength at a dose of 180 mJ/cm² in the plate setter. The printing plate was then developed using PDI's 177D developer solvent, available from Printing Developments, Inc. of Racine, Wis. In use this coated plate demonstrated a durability of up to 500,000 impressions without either pre-baking or post-baking the plate.

### EXAMPLE 2

The procedure of Example 1 was followed except that an additional step was applied as described below. After the UV exposure of the plate prepared as in Example 1, instead of image exposing the plate the plate was first treated by heating at 265° F. for 60 seconds. The final plate was made by following the same laser imaging and developing procedure as above.

This thermally treated plate demonstrated a durability of up to approaching 1,000,000 impressions without either pre-baking or post-baking the plate.

### EXAMPLE 3

The procedure of Example 2 was followed except a post thermal treatment at a temperature of 255° F. (125° C.) and another at 260° F. (120° C.) was applied. Both the thermally treated plates demonstrated a durability of up to 1,000,000 impressions without pre-baking or post-baking the plate.

### EXAMPLE 4

The photoresist solution was prepared by dissolving 3.35 parts of polyvinyl formal resin, 0.3 parts of modified polyvinyl formal resin, 0.36 parts of azido bis(2,6-benzylidene) cyclohexanone, 0.13 parts of Infrared dye KF898, available from Honeywell Inc., 0.02 parts of the surfactant FC-431 (available from 3M Company), in 96 parts of a mixture of 66:33% of Xylene and dimethyl acetamide solvent system.

The solution was filtered and spin-coated onto Aluminum (which has been made as described hereinabove) surface at 60 rpm for 1 minute, dried for 2 minutes at 270° F. The plate was exposed to ultraviolet light at 200 mJ/cm².

The plate was then image exposed using a computer controlled diode laser with 830 mm wavelength at a dose of 180 mJ/cm² in the plate setter. The printing plate was then developed using PDI's 177D developer solvent, available from Printing Developments, Inc. This coated plate demonstrated a durability of up to 500,000 impressions without either pre-baking or post-baking the plate.

### EXAMPLE 5

The procedure of Example 4 was followed except adding one more step as described below. Right after UV exposure, instead of image exposing the plate immediately, the plate was treated at 265° F. for 60 seconds. The final plate was made by following the same laser imaging and developing procedure as above.

This thermally treated plate demonstrated a durability of up to 1,000,000 impressions without either pre-baking or post-baking the plate.

### EXAMPLE 6

The procedure of Example 4 was followed except varying the post thermal treatment temperature at 255° F. and another at 260° F. Both the thermally treated plates demonstrated a durability of up to 1,000,000 impressions without either pre-baking or post-baking the plate.

Although the invention has been described in terms of specific embodiments and ingredients, one skilled in the art will know that other ingredients can be substituted, including the photoresist. Thus, the invention is only to be limited by the scope of the appended claims.

1. A method of enhancing the chemical and resistance to abrasion durability of a metal substrate printing plate coated with an azide containing cross-linkable polymer and an IR sensitive dye comprising (a) drying the coated printing plate at a temperature of from about 265° F. to about 290° F.; (b) flood exposure with ultra violet light; and (c) post-thermal treating the plate at a temperature of from about 120° C. to about 150° C. for periods of from about 50 to about 150 seconds.

2. A method according to claim 1 wherein the post thermal treatment is conducted at a temperature of from about 125° C. to about 135° C. for a period of about 90 to 95 seconds.

3. A method according to claim 1 wherein the thermal treatment of the printing plates is effected in a plurality of stages.

4. A method according to claim 1 wherein the azide containing/IR sensitive dye coating is applied by spin coating on the printing plate substrate.

5. The method of claim 1 wherein the prepared plate is image exposed in step (b) using a computer controlled laser.

6. The method of claim 1 wherein the azide containing cross linkable polymer resin comprises a polyvinyl formal resin admixed with an azide bis (2,6-benzylidene) cyclohexanone.

7. A printing plate obtained according to the method of claim 1.

8. A printing plate obtained according to the method of claim 3.

9. A printing plate obtained according to the method of claim 4.

10. A printing plate obtained according to the method of claim 5.

11. A printing plate obtained according to the method of claim 6.
